(19) United States
(12) Patent Application Publication
(10) Pub. No.: US 2026/0178699 A1
(43) Pub. Date: Jun. 25, 2026

(54) INFORMATION PROCESSING APPARATUS AND INFORMATION PROCESSING METHOD

(71) Applicant: Hitachi, Ltd., Tokyo (JP)

(72) Inventor: Takashi OSHIMA, Tokyo (JP)

(21) Appl. No.: 19/424,538

(22) Filed: Dec. 18, 2025

(30) Foreign Application Priority Data
Dec. 23, 2024 (JP) 2024-226078

(51) Int. Cl. G06F 17/16; G06F 5/01

(52) U.S. Cl. CPC G06F 17/16; G06F 5/01

(57) ABSTRACT

An object of the present invention to execute high-performance AI models (large-scale neural networks), including generative AI, in real time on hardware with limited computational resources or power capacity.

One aspect of the present invention is an information processing apparatus including a matrix multiplication unit including a multiplier and an accumulator, the matrix multiplication unit being configured to perform a matrix operation on an input signal to output an analysis result for the input signal. The information processing apparatus includes a bit length variable unit. In the matrix operation, multiplication of a first matrix and a second matrix is performed to output a third matrix as a multiplication result. In the multiplication, a first element of the third matrix is calculated, and in order to calculate the first element, multiplication of a second element of the first matrix and a third element of the second matrix is performed. The bit length variable unit executes the multiplication by setting the second element to have a first bit length based on a value of the third element.

### BACKGROUND OF THE INVENTION

### 1. Field of the Invention

The present invention relates to an information processing technology suitable for realizing AI (Artificial Intelligence).

### 2. Description of the Related Art

With the rapid advancement of generative AI and the like, it is possible to run high-performance AI in data centers. However, advanced AI models (neural networks), including generative AI, are large in scale, requiring high AI computing performance and a large amount of power. On the other hand, many products are limited in terms of cost, power (power supply, heat dissipation), and installation size. For this reason, only the limited amount of computational resources (hardware) can be mounted. When executing the enormous computational load of advanced AI using limited computational resources, the processing time increases, making it impossible to obtain results in real time.

As a method for reducing the amount of computation of generative AI or image recognition AI (convolutional neural networks) to increase the speed, pruning techniques are known. There are two types of pruning: structured pruning, which removes a continuous region of a neural network all at once, and unstructured pruning, which thins out regions randomly. Structured pruning is easy to implement using the hardware structure of existing AI processors, but there is a problem of reduced accuracy. On the other hand, unstructured pruning can mitigate accuracy degradation. However, at present, although hardware exists that supports neural networks with low sparsity, hardware support for random neural networks with high sparsity remains a challenge.

As another method for reducing the amount of computation, a quantization technique is known. Instead of conventional 32-bit floating-point operations or 64-bit floating-point operations, reduced arithmetic bit lengths such as 8-bit integer operations (INT8), 4-bit integer operations (INT4), 16-bit floating-point operations (FP16), Bfloat16 (BF16), and 8-bit floating-point operations (FP8) are applied. This approach leverages the fact that neural networks are structurally redundant and therefore tolerant to quantization errors. However, most current hardware performs quantization only at the level of individual functional blocks within the neural network. That is, within a single functional block, computations are performed with the same bit length regardless of the characteristics of data being processed. For this reason, it is still insufficient to run advanced AI, such as generative AI, in real time on limited computational resources.

As an example of a device that performs matrix operations included in the computations of conventional neural networks, a device disclosed in JP-A-2022-74442 is known. In view of the above circumstances, the present invention has been made.

### SUMMARY OF THE INVENTION

It is an object of the present invention to execute high-performance AI models (large-scale neural networks), including generative AI, in real time on hardware with limited computational resources or power capacity.

One aspect of the present invention is an information processing apparatus including a matrix multiplication unit including a multiplier and an accumulator, the matrix multiplication unit! configured to perform a matrix operation on an input signal to output an analysis result for the input signal. The information processing apparatus includes a bit length variable unit. In the matrix operation, multiplication of a first matrix and a second matrix is performed to output a third matrix as a multiplication result. In the multiplication, a first element of the third matrix is calculated, and in order to calculate the first element, multiplication of a second element of the first matrix and a third element of the second matrix is performed. The bit length variable unit performs the multiplication by setting the second element to have a first bit length based on a value of the third element.

Another aspect of the present invention is an information processing method including: when a matrix multiplication unit including a multiplier and an accumulator performs a matrix operation on an input signal to obtain an output corresponding to the input signal, performing multiplication of a first matrix and a second matrix to output a third matrix as a multiplication result in the matrix operation; calculating a first element of the third matrix in the multiplication, and in order to calculate the first element, performing multiplication of a second element of the first matrix and a third element of the second matrix; and performing the multiplication by setting the second element to have a first bit length based on a value of the third element using a bit length variable unit.

According to the present invention, it is possible to execute high-performance AI models, including generative AI, in real time on hardware with limited computational resources or power capacity.

### BRIEF DESCRIPTION OF THE DRAWINGS

FIG. 1 is a block diagram showing the configuration of a first embodiment of the present invention;

FIG. 2 is a block diagram illustrating a bit length variable multiplier according to the first embodiment;

FIG. 3 is a block diagram illustrating a bit length variable unit according to the first embodiment;

FIG. 4A is an explanatory diagram illustrating matrix multiplication in the first embodiment;

FIG. 4B is an explanatory diagram illustrating matrix multiplication in the first embodiment;

FIG. 5 is a block diagram illustrating an effective bit length calculation unit according to the first embodiment;

FIG. 6A is an explanatory diagram illustrating matrix multiplication in a second embodiment of the present invention;

FIG. 6B is a time chart illustrating matrix multiplication in the second embodiment of the present invention;

FIG. 7 is a block diagram illustrating a bit length variable unit according to the second embodiment;

FIG. 8 is a block diagram illustrating a bit length variable multiplier according to a third embodiment of the present invention;

FIG. 9 is a block diagram illustrating a bit length variable multiplier according to a fourth embodiment of the present invention;

FIG. 10 is a block diagram illustrating a fifth embodiment of the present invention; and

FIG. 11 is a table showing the quantitative effect of the fourth embodiment compared with a conventional method of performing matrix multiplication with a fixed bit length.

### DETAILED DESCRIPTION OF THE PREFERRED EMBODIMENTS

Embodiments will be described in detail with reference to the diagrams. However, the present invention should not be construed as being limited to the description of the embodiments below. It is easily understood by those skilled in the art that the specific configuration can be changed without departing from the idea or the spirit of the present invention.

In the configurations of the embodiments described below, the same portions or portions having the same functions are denoted by the same reference numerals in different diagrams, and repeated descriptions thereof may be omitted.

When there are a plurality of elements having the same or similar functions, these may be described using the same reference numerals with different subscripts. However, when it is not necessary to distinguish between the plurality of elements, the subscripts may be omitted in the description.

In this specification and the like, expressions such as “first,” “second,” and “third” are used to identify components, and do not necessarily limit the number, order, or content thereof. In addition, numbers for identifying components are used for each context, and numbers used in one context do not always indicate the same configuration in other contexts. In addition, this does not prevent a component identified by a certain number from having the function of a component identified by another number.

The position, size, shape, range, and the like of each configuration shown in the diagrams and the like may not represent the actual position, size, shape, range, and the like in order to facilitate understanding of the invention. Therefore, the present invention is not necessarily limited to the position, size, shape, range, and the like disclosed in the diagrams and the like.

The publications, patents, and patent applications cited in this specification are a part of the description of this specification as they are.

As used herein, in this specification, components expressed in the singular form are intended to include the plural form unless the context clearly indicates otherwise.

In one example of the embodiments described in detail below, in a multiplication of two numbers (a first value and a second value) performed in a matrix multiplication of a neural network, the bit length of the first value is set based on the magnitude of the second value. More specifically, the larger (smaller) the second value is, the larger (smaller) the bit length of the first value is set. More preferably, the bit length of the first value is set based on the logarithm (base 2) of the second value. Even more preferably, the multiplication is performed by expressing the first value in a bit-serial form and the second value in a bit-parallel form and finding a product of the bit-serial representation and the bit-parallel representation. In addition, the bit length of the first value based on the logarithm (base 2) of the second value may be calculated using a left bit shift of a shift register and a counter. In addition, which of the two numbers is to be set as the first value may be selected such that the larger (or non-smaller) of the two is designated as the first value.

According to such an embodiment, it is possible to realize adaptive quantization for each element of the matrix multiplication in a neural network. As a result, unnecessary computations are reduced, making it possible to run large-scale neural networks in real time even with limited computational resources or power capacity.

### First Embodiment

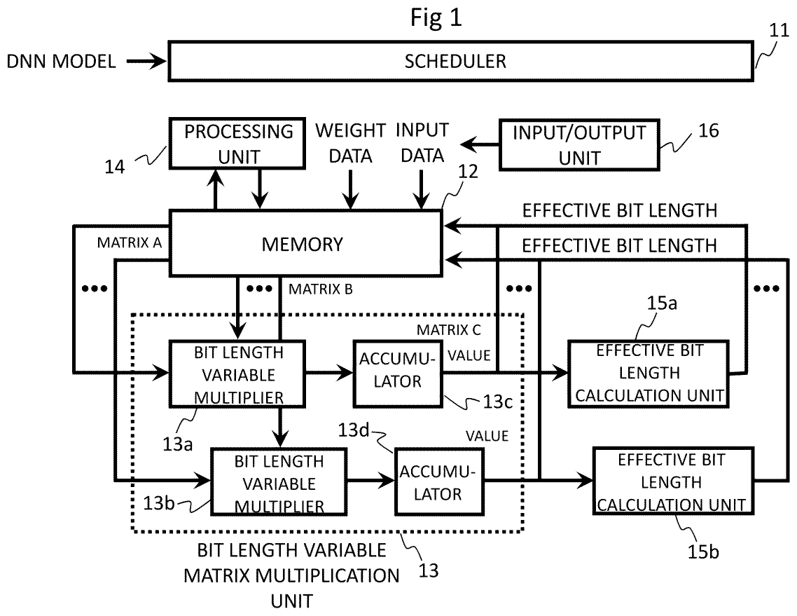

FIG. 1 shows the configuration of a first embodiment of the present invention. It targets a variety of AI, including generative AI or image recognition AI. AI is realized as a DNN (Deep Neural Network). A DNN model representing the layer structure of the DNN is input to a scheduler 11, and the scheduler 11 controls the operation of each of the following blocks based on the DNN model.

The AI computing device of the present embodiment executes computations related to DNN using a memory 12, a bit length variable matrix multiplication unit 13, and a processing unit 14. The bit length variable matrix multiplication unit 13 includes a plurality of bit length variable multipliers 13a to 13b and accumulators 13c to 13d subsequent thereto. Using these, matrix multiplication, among the DNN-related operations, is performed. In addition, the processing unit 14 performs operations other than matrix multiplication among the DNN-related operations.

In the present embodiment, an example will be described in which a large-scale neural network is executed in real time on hardware with limited computational resources or power capacity. In a neural network, it is necessary to perform matrix calculations as described in JP-A-2022-74442. In the present embodiment, by providing hardware that performs adaptive quantization on each element of matrix multiplication in the neural network, unnecessary computations can be reduced. As a result, a large-scale neural network can be executed in real time even with limited computational resources or power capacity.

Each of the bit length variable multipliers 13a to 13b and the subsequent accumulators 13c to 13d calculate one element of the output matrix. That is, the bit length variable multiplier 13a and the accumulator 13c calculate the first element of the output matrix. In addition, the bit length variable multiplier 13b and the accumulator 13d calculate the last element of the output matrix. In order to obtain matrix C as a multiplication result by multiplying matrix A by matrix B, the necessary elements of the matrices A and B are read from the memory 12 into each bit length variable multiplier.

For example, in order to calculate the first element of the output matrix C, the elements of the first row of the matrix A and the elements of the first column of the matrix B are sequentially read into the bit length variable multiplier 13a. In addition, in order to calculate the last element of the output matrix C, the elements of the last row of the matrix A and the elements of the last column of the matrix B are sequentially read into the bit length variable multiplier 13b. Each bit length variable multiplier sequentially multiplies the elements of the matrices A and B, and the subsequent accumulator integrates these multiplication results to perform a multiply-accumulate operation, thereby obtaining one element of the output matrix C.

The memory 12 stores information regarding the elements of the matrices A and B. As the information regarding the elements, the values of the elements and the effective bit lengths corresponding to the values are stored. The effective bit length is determined so as to increase (decrease) as the value of the element increases (decreases). As described above, when the necessary elements of the matrices A and B are read from the memory 12 into each bit length variable multiplier, the effective bit length is also read together with the values of the elements. When each bit length variable multiplier sequentially performs the multiplication of the elements of the matrix A and the elements of the matrix B as described above, this operation is performed using the values of the elements and the effective bit length.

The output of each accumulator is the value of each element of the output matrix C. These are stored in the memory 12 and used for the next matrix multiplication. In addition, the value of each element is also input to the effective bit length calculation unit following the accumulator. For example, the output of the multiplier 13c is the value of the first element of the output matrix C, and this is input to an effective bit length calculation unit 15a. The output of the multiplier 13d is the value of the last element of the output matrix C, and this i to an effective bit length calculation unit 15b.

Each effective bit length calculation unit calculates the effective bit length for the value of the element of the output matrix C that is input. The calculated effective bit length is stored in the memory 12 as a pair with the value of the corresponding element.

Through the above operation, the multiplication of two matrices is performed, and the new matrix obtained as a result of the multiplication is stored in the memory. At this time, as described above, the effective bit length is stored as a pair with the value of the matrix element. By repeating this operation, a large number of matrix multiplications required by the DNN can be sequentially performed.

In general, two numbers a and b are quantized to a+Q_{A} and b+Q_{B}, respectively, and then multiplied. Here, Q_{A} and Q_{B} are quantization errors (deviations from the true values) associated with the quantization of a and b, respectively, and decreases (increases) on average as the bit length representing a and b increases (decreases). Therefore, the actual multiplication result is expressed as shown in Equation (1).

$$\begin{matrix}[ Equation 1 ] & \\ ( a + {Q}_{A} ) \times ( b + {Q}_{B} ) = α \times b + b \times {Q}_{A} + a \times {Q}_{B} + {Q}_{A} \times {Q}_{B} ≅ a \times b + b \times {Q}_{A} + a \times {Q}_{B} & ( 1 )\end{matrix}$$

In the above Equation (1), the product of the quantization errors Q_{A}×Q_{B} is sufficiently small and is accordingly ignored. Therefore, for the first term a×b, which is the true value, the second term b×Q_{A} and the third term a×Q_{B} are errors. The second term, b×Q_{A}, is proportional to b. That is, if b is small, the error b×Q_{A} itself can be made small even if Q_{A} is large. Therefore, the bit length representing a can be made to decrease as b decreases. Conversely, as b increases, Q_{A} needs to decrease, and accordingly, the bit length representing a needs to be increased. The bit length variable multiplier in the present embodiment focuses on this point.

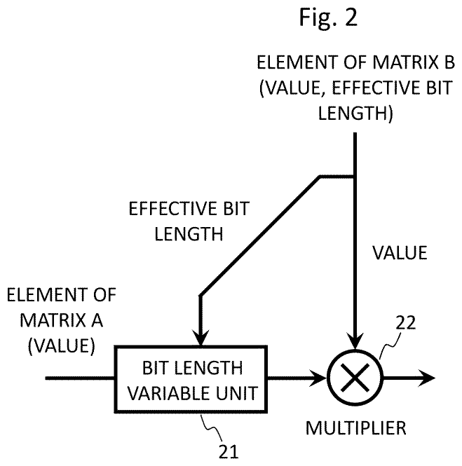

The operation of the bit length variable multipliers 13a and 13b will be described with reference to FIG. 2. The multiplication of an element a of matrix A and an element b of matrix B is performed. As described above, the value of the element a of the matrix A is read from the memory 12. In addition, the effective bit length corresponding to the value of the element b of the matrix B is read from the memory 12. In the bit length variable unit 21, the bit length of the element a is set based on the effective bit length of the element b. The multiplier 22 multiplies the value of the element a, for which the bit length is set, by the value of the element b, and outputs the multiplication result. In this manner, as described above, the bit length representing a is made to decrease (increase) as b decreases (increases).

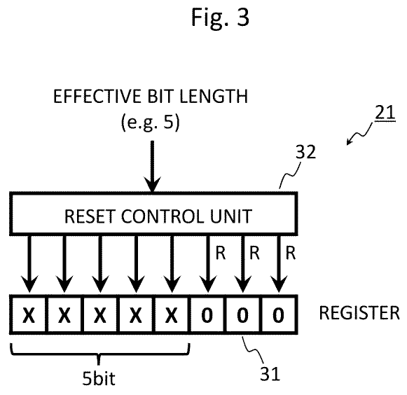

FIG. 3 shows an example of the variable bit length unit 21. For example, it is assumed that the value of the element a of the matrix A is stored in the memory 12 with a bit length of 8 bits. In addition, the bit length (8 bits in this example) for storing the value of each element is fixed, and does not refer to the effective bit length. The value of the element a with an 8-bit length read from the memory 12 is stored in an 8-bit register 31. Then, a reset control unit 32 replaces the lower bits of the register 31 with 0 based on the effective bit length corresponding to the value of the element b of the matrix B. FIG. 3 shows an example in which the effective bit length is 5. The element a stored in the register 31 as an 8-bit length is set to a 5-bit length, which is equal to the effective bit length. To do this, only the upper 5 bits are retained, and the lower 3 bits are replaced with zero.

In this manner, the bit length variable unit 21 replaces more of the lower bits of the element a with zero as the value of the element b becomes smaller. In the present embodiment, this achieves an equivalent reduction in bit length. By replacing unnecessary bits with zero, unnecessary voltage changes (voltage toggling) in the subsequent multiplier 22 are reduced, and as a result, power consumption due to charging and discharging of parasitic capacitance can be reduced.

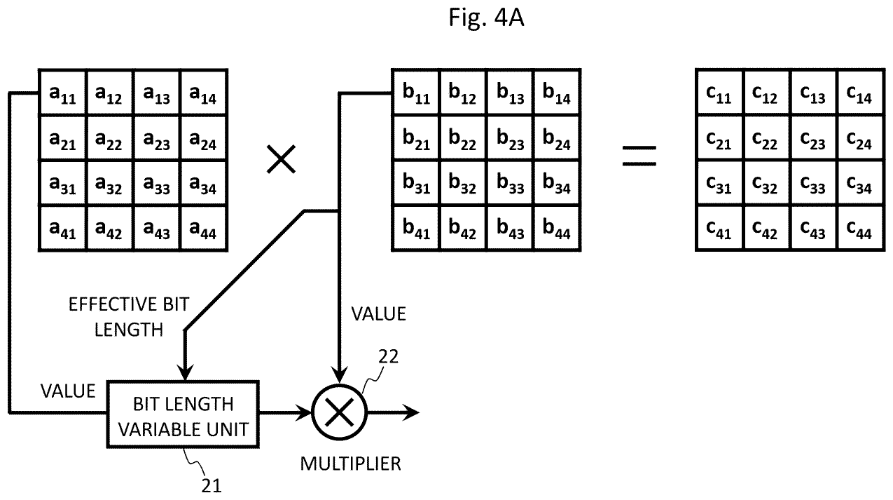

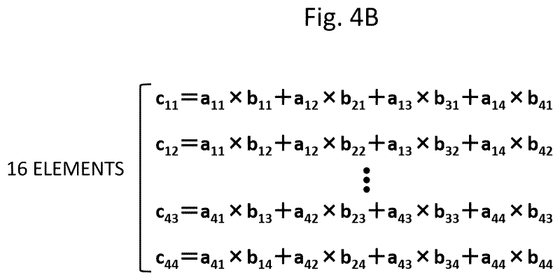

The matrix multiplication in the present embodiment will be described in more detail with reference to FIG. 4A. FIG. 4A shows a case where the bit length variable multipliers 13a and 13b multiply a 4×4 matrix A by a 4×4 matrix B to obtain a 4×4 matrix C as the multiplication result, but the same applies to matrices of other sizes. c₁₁, Which is the first element of the output matrix C is expressed shown in Equation (2).

$$\begin{matrix}[ Equation 2 ] & \\ {c}_{11} = {a}_{11} \times {b}_{11} + {a}_{12} \times {b}_{21} + {a}_{13} \times {b}_{31} + {a}_{14} \times {b}_{41} & ( 2 )\end{matrix}$$

Therefore, in order to calculate c₁₁, the value of the element a₁₁ of the matrix A is read from the memory 12 as described above. In addition, the value of the element a₁ of the matrix B and the corresponding effective bit length are read from the memory 12. The bit length variable unit 21 sets the bit length of the element am based on the effective bit length of the element b₁₁ as described above. In the present embodiment, the bit length is adjusted by replacing the lower bits of the element am with zero as described above.

The multiplier 22 multiplies the value of the element a₁₁, for which the bit length is set, by the value of the element b₁₁ and outputs the multiplication result a₁₁×b₁₁ to the subsequent accumulator 13c. Similarly, the value of the element a₁₂ of the matrix A is then read from the memory 12. In addition, the value of the element b₂₁ of the matrix B and the corresponding effective bit length are read from the memory 12. The bit length variable unit 21 sets the bit length of the element a₁₂ based on the effective bit length of the element b₂₁, and the multiplier 22 multiplies the value of the element a₁₂, for which the bit length is set, by the value of the element b₂₁ and outputs the multiplication result a₁₂×b₂₁ to the subsequent accumulator 13c. Similarly, the multiplications a₁₃×b₃₁ and a₁₄×b₄₁ are sequentially performed, and the results are output to the accumulator 13c.

As shown in FIG. 4B, the accumulator 13c calculates c₁₁ in Equation (2) by accumulating a₁₁×b₁₁, a₁₂×b₂₁, a₁₃×b₃₁, and a₁₄×b₄₁ that are sequentially input.

Similarly, other elements of the output matrix C are simultaneously calculated using other bit length variable multipliers and accumulators. For example, the last element c₄₄ is expressed as shown in Equation (3).

$$\begin{matrix}[ Equation 3 ] & \\ {c}_{44} = {a}_{41} \times {b}_{14} + {a}_{42} \times {b}_{24} + {a}_{43} \times {b}_{34} + {a}_{44} \times {b}_{44} & ( 3 )\end{matrix}$$

Therefore, in order to calculate c₄₄, the value of the element a₄₁ of the matrix A is read from the memory 12. In addition, the value of the element b₁₄ of the matrix B and the corresponding effective bit length are read from the memory 12. The bit length variable unit 21 sets the bit length of the element a₄₁ based on the effective bit length of the element b₁₄. The multiplier 22 multiplies the value of the element a₄₁, for which the bit length is set, by the value of the element b₁₄ and outputs the multiplication result a₄₁×b₁₄ to the subsequent accumulator 13d. Similarly, the multiplications a₄₂×b_{24, 243}×b₃₄, and a₄₄×b₄₄ are sequentially performed, and the results are output to the accumulator 13d.

As shown in FIG. 4B, the accumulator 13d calculates c₄₄ in Equation (3) by accumulating a₄₁×b₁₄, a₄₂×b₂₄, 243×b₃₄ and a₄₄×b₄₄ that are sequentially input.

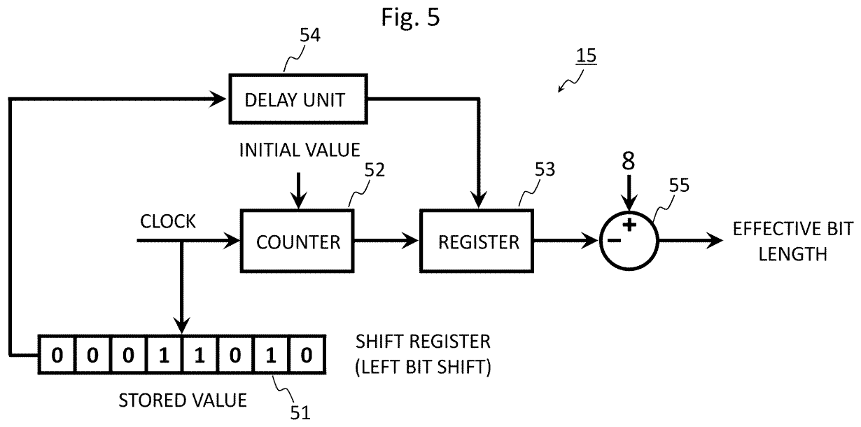

The operation of the effective bit length calculation unit 15 in the present embodiment will be described in more detail with reference to FIG. 5. The values of elements of the output matrix C calculated by the preceding accumulator are input to the effective bit length calculation unit 15. These values are stored in a shift register 51 shown in FIG. 5. The shift register 51 can perform left bit shifting.

A clock is applied to the shift register 51, and the values of the elements are read out sequentially from the most significant bit by left bit shifts synchronized with the clock. At the same time, the clock is applied to a counter 52, and the output of the counter 52 increases by one in synchronization with the clock. FIG. 5 shows an example in which the values of elements are expressed in 8-bit length, for example. Therefore, the shift register 51 is also 8-bit long. In this case, the counter 52 may be a 3-bit counter circuit capable of outputting eight values from 0 to 7 sequentially. Prior to applying the clock, the initial value of the output of the counter 52 is set to 7.

The output of the counter 52 is input to a register 53. The register 53 receives and outputs the output of the counter 52 at the timing when 1 is first read from the shift register 51. For example, if the most significant bit of the value of the element is 1, 1 is read out from the shift register 51 in synchronization with the first rising edge of the clock. In addition, the output of the counter 52 changes from the initial value of 7 to 0 in synchronization with the first rising edge of the clock. Using the readout of the value 1 from the shift register 51 as a trigger, the register 53 receives and output the value 0 that is the output of the counter 52.

In addition, a delay unit 54 is inserted between the shift register 51 and the register 53. This is because, after the output of the counter 52 changes, a necessary time is secured before triggering the capture into the register 53. By delaying the readout signal from the shift register 51 using the delay unit 54, the necessary time can be secured.

If the most significant bit of the value of the element is 0 and the next bit is 1, 1 is read out from the shift register 51 in synchronization with the second rising edge of the clock. At that time, the counter 52 outputs 1. Therefore, using the readout of 1 from the shift register 51 as a trigger, the register 53 receives and output the value 1 that is the output of the counter 52.

Similarly, as shown in FIG. 5, when the fourth most significant bit of the value of the element is the first 1, 1 is read out from the shift register 51 in synchronization with the fourth rising edge of the clock. At that time, the counter 52 outputs 3. Therefore, using the readout of 1 from the shift register 51 as a trigger, the register 53 receives and output the value 3 that is the output of the counter 52.

Thus, if the first 1 in the value of the element is the m-th bit from the most significant bit, the register 53 outputs m−1. In addition, in a subtractor 55, m−1, which is the output of the register 53, is subtracted from 8. As a result, 9−m (=8−(m−1)) is output from the subtractor 55, which is the effective bit length corresponding to the value of the element.

For example, when the value of the element is in the range of 128 to 255, m=1, so that 9-m, which is the effective bit length, is 8. In addition, when the value of the element is in the range of 64 to 127, the effective bit length is 7 (m=2), when the value of the element is in the range of 32 to 63, the effective bit length is 6 (m=3), when the value of the element is in the range of 16 to 31, the effective bit length is 5 (m=4), when the value of the element is in the range of 8 to 15, the effective bit length is 4 (m=5), when the value of the element is in the range of 4 to 7, the effective bit length is 3 (m=6), when the value of the element is in the range of 2 to 3, the effective bit length is 2 (m=7), and when the value of the element is 1, the effective bit length is 1 (m=8).

In addition, when the value of the element is 0, the values of all bits of the shift register 51 are zero. For this reason, 1 is not read out from the shift register 51 at the first to eighth rising edges of the clock. Therefore, the output of the register 53 does not change from the initial value. Therefore, for example, by setting the initial value of the register 53 to 7 (or 8) in advance, the output of the subtractor 55 may be made to be 1 (or 0) when the value of the element is 0. In this case, when the value of the element is 0, the effective bit length is 1 (or 0).

In this manner, with the configuration shown in FIG. 5, an approximate value of the logarithm (base 2) of the value of the element can be obtained as the effective bit length. The error during multiplication is expressed as the second term b×Q_{A} in Equation (1). Therefore, when the value of the element b is halved, the quantization error Q_{A} of the element a can be allowed to double. That is, the bit length of the element a during multiplication may be reduced by 1 bit. In addition, when the value of the element b becomes ¼ times (⅛ times), the quantization error Q_{A} of the element a can be allowed to increase by four times (or eight times). That is, the bit length of the element a during multiplication may be reduced by 2 bits (3 bits). As described above, since the bit length of the element a during multiplication is set based on the effective bit length corresponding to the value of the element b, an approximate value of the logarithm (base 2) of the value of the element may be calculated as the effective bit length by using the configuration in FIG. 5. In addition, since this approximation does not directly affect the multiplication result, this can be used as an approximation without any problem.

In addition, as shown in FIG. 1, input data for the DNN or weight data of the DNN are also read into the memory 12. These pieces of data are also stored in the memory 12 as pairs of values and effective bit lengths, and are used during the matrix multiplication.

When the present embodiment is applied to the DNN and the like, the aforementioned numbers a and b correspond to the vector components of the input data for the DNN or the weight data of the DNN. The input data for the DNN is usually a physical quantity (or its feature quantity), such as two-dimensional image data or time-series data. For example, the input data is acquired from various sensors and input to the memory 12 from an input/output unit 16.

In general, a DNN has a multi-layer structure, and matrix calculations are repeatedly performed thereinside. As an example, in FIG. 1, a matrix C is obtained as the calculation result. However, when this is configured as a DNN, the matrix C is, for example, the node output of the first stage of the DNN. Assuming that the matrix B is the weight, the matrix C becomes the next matrix A, which becomes the input to the second stage of the DNN, and the matrix calculation is repeated. Although the matrix calculators can be configured in series, the circuit scale can be reduced with the configuration shown in FIG. 1.

Regarding the node output, as described above, it is necessary to calculate the effective bit length each time. However, since the weight data is predetermined based on the DNN model, the effective bit length can be stored in the memory 12 in advance in association with the weight data. However, only the weight data may be stored data, and the bit length of the weight data may be calculated before matrix calculation, but storing the bit length in advance enables faster calculations and is therefore suitable for real-time processing.

The DNN can function, for example, as a filter for input data to obtain a desired output. According to the configuration of the present embodiment, even when the input data is input as real-time data from a sensor, the load of calculation processing can be reduced, making it possible to obtain real-time output at high speed.

As described above, according to the present embodiment, unnecessary voltage changes (voltage toggles) associated with the lower bits of each matrix element in the matrix multiplication required for the DNN are reduced, and as a result, power consumption due to charging and discharging of parasitic capacitance can be reduced. Therefore, matrix multiplication can be performed at higher speed for the same power consumption. This enables real-time AI execution even when the power capacity is limited.

### Second Embodiment

A second embodiment of the present invention will be described. In the present embodiment, the multiplication by the multiplier 22 in the first embodiment is performed as a multiplication between a bit-serial representation and a bit-parallel representation. Therefore, the bit length variable unit 21 in the first embodiment also operates differently from that in the first embodiment. Other than that, the second embodiment is the same as the first embodiment.

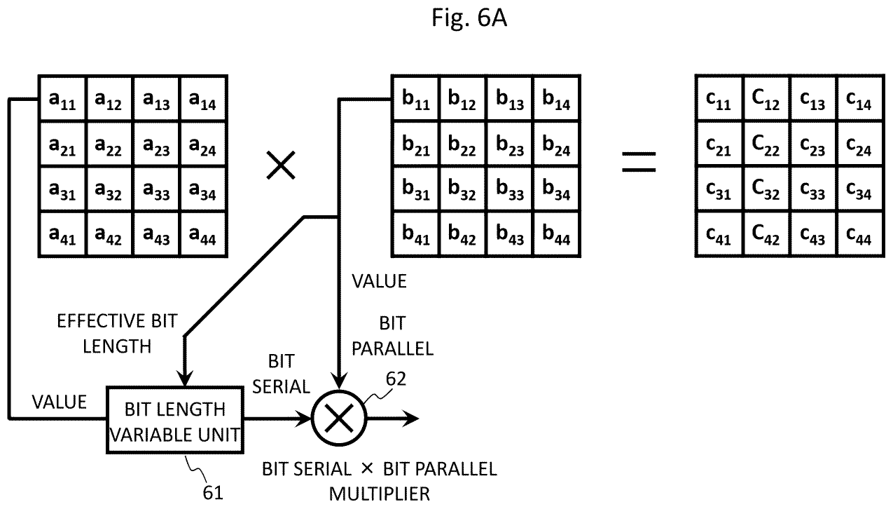

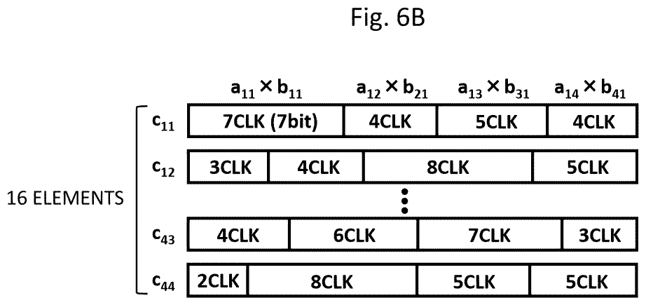

The present embodiment will be described in detail with reference to FIG. 6A. In the present embodiment as well, a 4×4 matrix A is multiplied by a 4×4 matrix B to obtain a 4×4 output matrix C as the multiplication result, but the same applies to matrices of other sizes. The first element of the output matrix C, c₁₁, is given by Equation (2). Therefore, in order to calculate c₁₁, as described above, the value of the element a₁₁ of the matrix A is read from the memory 12. In addition, the value of the element b₁₁ of the matrix B and the corresponding effective bit length are read from the memory 12. The bit length variable unit 61 sets the bit length of the element a₁₁ based on the effective bit length of the element b₁₁ as described above.

In the present embodiment, unlike the first embodiment, the bit length variable unit 61 extracts a bit string having the same length as the effective bit length of the element b₁₁ from the most significant bit of the bit string representing the element a₁₁, and outputs the bit string sequentially from the most significant bit. That is, the bit length variable unit 61 outputs the element am in a bit-serial representation. At this time, the bit length variable unit 61 does not output the lower bits exceeding the bit length equal to the effective bit length of the element b₁₁. As a result, the bit length of the element a₁₁ is reduced before being supplied to the multiplier 62.

The multiplier 62 performs multiplication between the value of the element a₁₁ expressed in a bit-serial form and the value of the element b₁₁ expressed in a bit-parallel form, and outputs the multiplication result a₁₁×b₁₁ to the subsequent accumulator 13c. Therefore, the multiplier 62 is a circuit that can perform multiplication between a bit-serial representation and a bit-parallel representation.

The multiplication circuit, for example, performs an AND operation between the most significant bit of the bit-serial representation and all the bits of the bit-parallel representation during a first clock period. In the subsequent second clock period, the multiplication circuit performs an AND operation between the next bit of the bit-serial representation and all the bits of the bit-parallel representation. This process is repeated in the same manner, and finally, during the N-th clock period, an AND operation is performed between the N-th bit of the bit-serial representation (assumed to be an N-bit representation) and all the bits of the bit-parallel representation. The results of these AND operations are added with binary weighting and output as the multiplication result.

Therefore, the number of clocks required for multiplication between the bit-serial representation and the bit-parallel representation is approximately equal to the number of bits (N) in the serial representation. That is, the number of clocks required for multiplication is approximately equal to the shortened bit length of the element a₁₁, that is, the effective bit length of the element b₁₁.

Similarly, the value of the element a₁₂ of the matrix A is then read from the memory 12. In addition, the value of the element b₂₁ of the matrix B and the corresponding effective bit length are read from the memory 12. As described above, the bit length variable unit 61 outputs the element a₁₂ in a bit-serial representation with a bit length equal to the effective bit length of the element b₂₁. The multiplier 62 performs multiplication between the value of the element a₁₂ expressed in a bit-serial form and the value of the element b₂₁ represented in a bit-parallel form, and outputs the multiplication result a₁₂×b₂₁ to the subsequent accumulator 13c. The number of clocks required for the multiplication is approximately equal to the effective bit length of the element b₂₁. Similarly, the multiplications a₁₃×b₃₁ and a₁₄×b₄₁ are sequentially performed, and the results are output to the accumulator 13c. The accumulator 13c calculates c₁₁ in Equation (2) by accumulating the multiplication results a₁₁×b₁₁, a₁₂×b₂₁, a₁₃×b₃₁, and a₁₄×b₄₁ that are sequentially input.

FIG. 6B shows an example of a time chart. In this example, the effective bit lengths of the elements b₁₁, b₂₁, b₃₁, and b₄₁ are 7 bits, 4 bits, 5 bits, and 4 bits, respectively. As a result, the multiplications a₁₁×b₁₁, a₁₂×b₂₁, a₁₃×b₃₁, and a₁₄×b₄₁ in the multiplier 62 require 7 clocks (7 CLK), 4 clocks, 5 clocks, and 4 clocks, respectively. Therefore, the first element c₁₁ of the output matrix C is calculated over a total of 20 clock period.

Similarly, other elements of the output matrix C are simultaneously calculated using other bit length variable multipliers and accumulators. For example, the last element c₄₄ is expressed as shown in Equation (3). Therefore, in order to calculate c₄₄, the value of the element a₄₁ of the matrix A is read from the memory 12. In addition, the value of the element b₁₄ of the matrix B and the corresponding effective bit length are read from the memory 12. The bit length variable unit 61 outputs the element a₄₁ in a bit-serial representation with a bit length equal to the effective bit length of the element b₁₄. The bit length variable unit 61 performs multiplication between the value of the element a₄₁ represented in a bit-serial form and the value of the element b₁₄ represented in a bit-parallel form, and outputs the multiplication result a₄₁×b₁₄ to the subsequent accumulator 13d. The number of clocks required for the multiplication is approximately equal to the effective bit length of the element b₁₄. Similarly, the multiplications a₄₂×b₂₄, a₄₃×b₃₄, and a₄₄×b₄₄ are sequentially performed, and the results are output to the accumulator 13d. The accumulator 13d calculates c₄₄ in Equation (3) by accumulating the multiplication results a₄₁×b₁₄, a₄₂×b₂₄, a₄₃×b₃₄, and a₄×b₄₄ that are sequentially input.

In the example of the time chart shown in FIG. 6B, the effective bit lengths of the elements b₁₄, b₂₄, b₃₄, and b₄₄ are 2 bits, 8 bits, 5 bits, and 5 bits, respectively. As a result, the multiplications of a₄₁×b₁₄, a₄₂×b₂₄, 243×b₃₄, and a₄₄×b₄₄ in the multiplier 62 requires 2 clocks (2 CLK), 8 clocks, 5 clocks, and 5 clocks, respectively. Therefore, the final element c₄₄ of the output matrix C is calculated over a total of 20 clock period. Similarly, for each of the other elements of the output matrix C, a total of 20 clock period is required for calculation.

In this example, the period required for calculation of all elements of the output matrix C is the same. For this reason, no unnecessary idle time occurs while waiting for other element calculations to finish. Therefore, it is possible to speed up matrix multiplication by taking advantage of the shortened bit length.

In practice, the calculation time (the number of required clocks) for all elements of the output matrix C is not necessarily the same. However, if the matrix size (the number of rows or columns of the matrix) is sufficiently large, the number of multiplications required to calculate each element (=the number of rows or columns of the matrix). Therefore, the ratio between multiplications that require clocks (when the effective bit length of the element b is large) and multiplications that do not require clocks (when the effective bit length of the element b is small) becomes uniform across the elements. As a result, the total number of clocks required to calculate each element becomes uniform, and the variations are reduced. Therefore, the unnecessary idle time becomes relatively small, and the matrix multiplication can be performed at high speed by taking advantage of the shortened bit length.

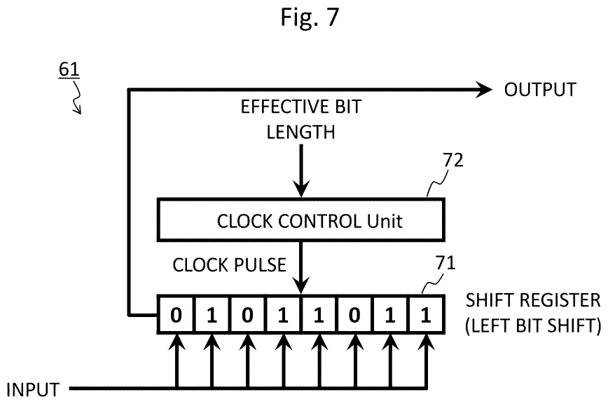

FIG. 7 shows an example of the implementation of the bit length variable unit 61 in the present embodiment. As described above, the element a of the matrix A is input to the bit length variable unit and stored in a shift register 71. The shift register 71 can perform left bit shifting. In addition, as in the first embodiment, an example is shown in which the value of each element a of the matrix A is stored in the memory 12 with a length of 8 bits and the value is read from the memory 12 and stored in the 8-bit shift register 71.

Then, as described above, the effective bit length corresponding to the element b of the matrix B is read from the memory 12 (together with the value of the element b) and input to a clock control unit 72. The clock control unit 72 generates clock pulses the number of which is equal to the effective bit length, and performs left bit shifting of the shift register 71 using the clock pulses as a trigger. As a result, from the shift register 71, a bit string having the same length as the effective bit length of the element b is extracted from the most significant bit of the bit string representing the element a and output as an output of the bit length variable unit.

As described above, according to the present embodiment, operations related to the unnecessary lower bits of each matrix element are reduced in the matrix multiplication required for the DNN, so that matrix multiplication can be performed at high speed. This makes it possible to run AI in real time even on hardware with limited computational resources.

### Third Embodiment

A third embodiment of the present invention will be described. In the first or second embodiment, the configuration focused on the second term on the right side of Equation (1). That is, in the multiplication of the matrices A and B, when each element b of the matrix B is small, the bit length of the element a of the matrix A, which is the multiplication counterpart, is shortened (that is, the quantization error Q_{A} is allowed to increase), thereby achieving an improvement in matrix multiplication speed and a reduction in power consumption.

In the present embodiment, further attention is given to the third term on the right side of Equation (1), a×Q_{B}. That is, in the multiplication of the matrices A and B, when each element a of the matrix A is small, the bit length of the element b of the matrix B, which is s the multiplication counterpart, is shortened (that is, the quantization error Q_{B} is allowed to increase), thereby achieving a further improvement in matrix multiplication speed and a further reduction in power consumption.

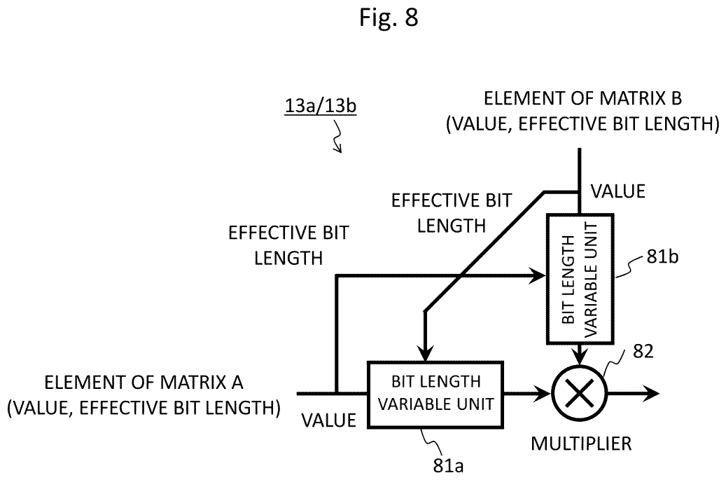

The bit length variable multiplier in the present embodiment will be described with reference to FIG. 8. FIG. 8 shows bit length variable multipliers 13a and 13b of the bit length variable matrix multiplication unit 13. The bit length variable multiplier in the first or second embodiment is added to the element side of the matrix B as a bit length variable unit 81b. The value of the element b of the matrix B is input to the bit length variable unit 81b, and the bit length variable unit 81b shortens the bit length of the element b based on the effective bit length corresponding to the element a of the matrix A using the same method as in the first or second embodiment. Therefore, the corresponding effective bit length is read from the memory 12 together with the value of the element a of the matrix A, and the effective bit length is supplied to the bit length variable unit 81b.

Other operations are the same as those in the first and second embodiments. When the bit length variable units 81a and 81b replace unnecessary lower bits with zeros as in the first embodiment, the multiplier 82 performs multiplication between bit-parallel representations. As a result of the replacement with zero described above, unnecessary voltage changes (voltage toggles) can be further reduced, and power consumption due to charging and discharging of parasitic capacitance can be further reduced.

When the bit length variable units 81a and 81b output shortened bit-serial representations as in the second embodiment, the multiplier 82 performs multiplication between the bit-serial representations. For example, multiplication between an N₁-bit serial representation and an N₂-bit serial representation requires the number of clocks of approximately N₁×N₂. As in the second embodiment, the execution speed of AI can be increased by not processing unnecessary lower bits.

### Fourth Embodiment

A fourth embodiment of the present invention will now be described. As in the third embodiment, both the second term b×Q_{A} and the third term a×Q_{B} on the right side of Equation (1) are addressed, so that it is possible to achieve a further improvement in matrix multiplication speed and a further reduction in power consumption compared with the first or second embodiment.

Unlike the third embodiment, no bit length variable multiplier is added. Instead, a comparison unit and a selection unit are used so that, in the multiplication of the element of the matrix A and the element of the matrix B, the element with the smaller value (that is, the element with the smaller corresponding effective bit length) is treated as the element b in the first and second embodiments, and the element with the larger value (that is, the element with the larger corresponding effective bit length) is treated as the element a in the first and second embodiments.

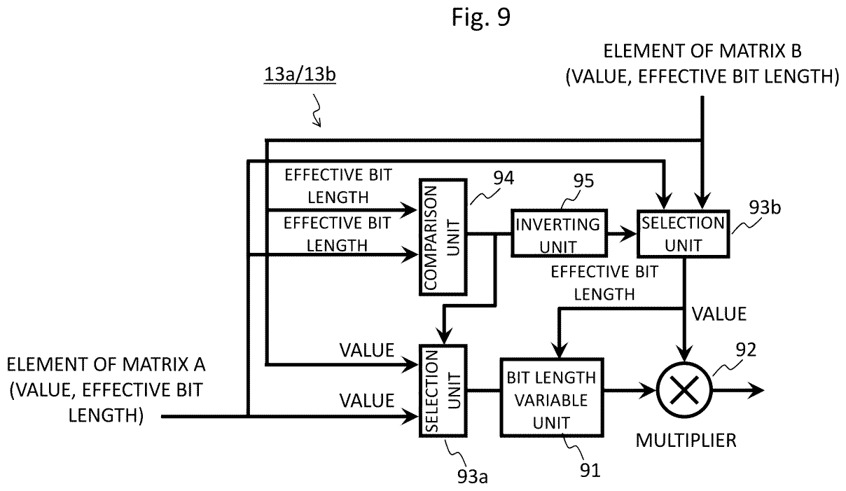

The bit length variable multiplier in the present embodiment will be described with reference to FIG. 9. FIG. 9 shows the bit length variable multipliers 13a and 13b of the bit length variable matrix multiplication unit 13. As in the third embodiment, the value of each element of the matrix A is read from the memory 12 together with the corresponding effective bit length. A comparison unit 94 determines which of the element of the matrix A and the element of the matrix B is smaller (or not larger).

In FIG. 9, it is determined which of the effective bit length of the element of the matrix A and the effective bit length of the element of the matrix B is smaller. However, it may be determined which of the value of the element of the matrix A and the value of the element of the matrix B is smaller.

When the comparison unit 94 determines that the element of the matrix B is smaller, a selection unit 93a selects the value of the element of the matrix A from the value of the element of the matrix A and the value of the element of the matrix B based on the determination result and supplies the selected value to the bit length variable unit 91. In addition, the determination result is passed through an inverting unit 95 to control a selection unit 93b, and the selection unit 93b selects the element of the matrix B from the element of the matrix A and the element of the matrix B, and supplies the effective bit length of the element of the matrix B to the bit length variable unit 91 and supplies the value of the element of the matrix B to a multiplier 92.

When the comparison unit 94 determines that the element of the matrix A is smaller, the selection unit 93a selects the value of the element of the matrix B from the value of the element of the matrix A and the value of the element of the matrix B based on the determination result and supplies the selected value to the bit length variable unit 91. In addition, the determination result is passed through the inverting unit 95 to control the selection unit 93b, and the selection unit 93b selects the element of the matrix A from the element of the matrix A and the element of the matrix B, and supplies the effective bit length of the element of the matrix A to the bit length variable unit 91 and supplies the value of the element of the matrix A to the multiplier 92.

Through the above operations, in the multiplication of the element of the matrix A and the element of the matrix B, the smaller element is treated as the element b in the first and second embodiments and the larger element is treated as the element a in the first and second embodiments, and the same configuration and operations can be applied to the others.

According to the present embodiment, it is possible to achieve a further improvement in matrix multiplication speed and a further reduction in power consumption compared with the first and second embodiments.

### Fifth Embodiment

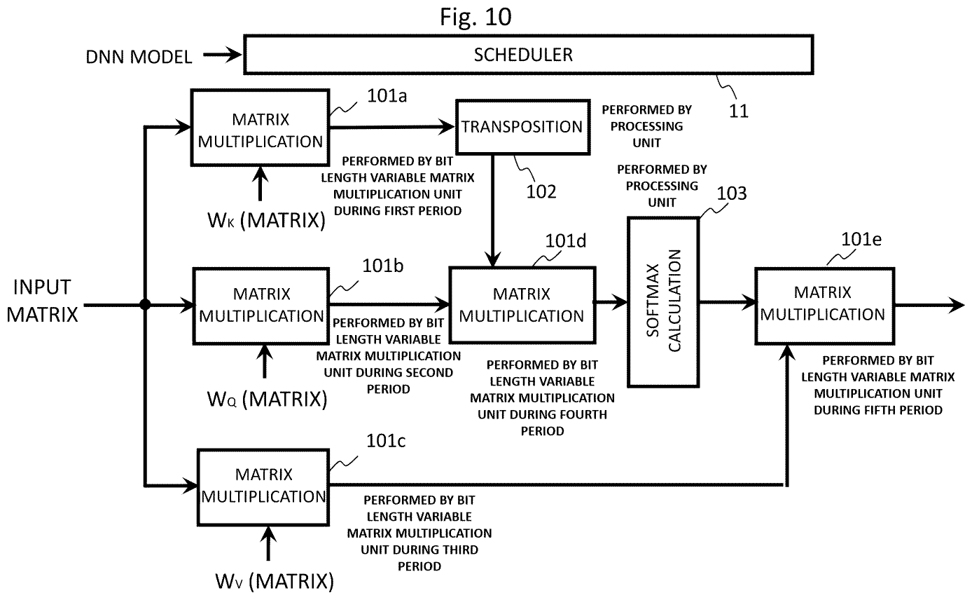

A fifth embodiment of the present invention will be described with reference to FIG. 10. As explained above, the present embodiment is more effective for DNNs that involve a large number of matrix multiplications and have large matrix sizes (number of rows or columns of a matrix). Therefore, the present embodiment is suitable for application to generative AI and high-accuracy image recognition AI.

The present embodiment shows an example of application to Transformer, which is a basic model of generative AI. DNNs in the Transformer make extensive use of attention structures. FIG. 10 shows an example in which calculations related to the attention structure are performed using the AI arithmetic device according to the present embodiment. As in each of the embodiments described above, the scheduler 11 controls the overall operation.

An input matrix is input to the attention structure, and the input matrix is multiplied by a key matrix WK, a query matrix WQ, and a value matrix WV through matrix multiplication processes 101a, 101b, and 101c, respectively.

In addition, a matrix obtained as a result of multiplying the input matrix by the key matrix is subjected to a matrix transposition process 102. In addition, a matrix obtained as a result of multiplying the input matrix by the query matrix is multiplied by a matrix after the matrix transposition process through a matrix multiplication process 101d. Based on the matrix obtained by the matrix multiplication process 101d, a Softmax calculation process 103 is performed. Finally, a matrix multiplication process 101e is performed between the matrix obtained as a result of multiplying the input matrix by the value matrix and the matrix obtained by the Softmax calculation process. As a result, the output of the attention structure is obtained.

In the present embodiment, the bit length variable matrix multiplication unit 13 in FIG. 1 is applied to the matrix multiplication processes 101a, 101b, 101c, 101d, and 101e in this order. First, the bit length variable matrix multiplication unit 13 performs the matrix multiplication process 101a during the first period. Thereafter, the matrix multiplication processes 101b, 101c, 101d, and 101e are similarly performed in this order during the second, third, fourth, and fifth periods. In addition, the matrix transposition process 102 or the Softmax calculation process 103 is performed using the processing unit 14 in FIG. 1.

### Sixth Embodiment

In many DNNs including Transformer, most of the elements of the matrices to be multiplied (matrix A, matrix B) are small values. Therefore, by applying the above-described embodiment, the calculation speed is improved.

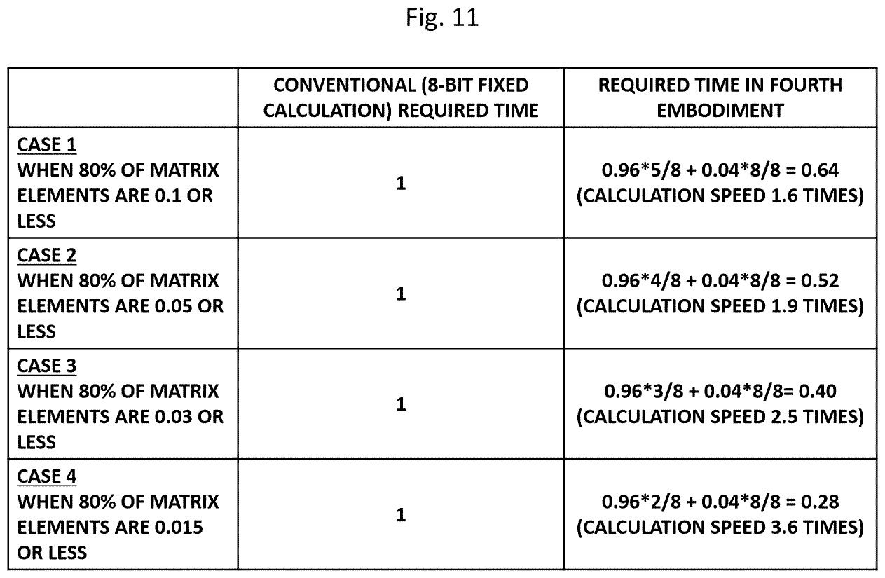

The table in FIG. 11 shows the quantitative effect of the calculation by the hardware described in the fourth embodiment, compared with a conventional method of performing matrix multiplication using a fixed bit length (for example, 8 bits).

Case 1 in FIG. 11 is a case where 80% of the matrix elements are 0.1 or less (10% of the maximum value in 8-bit representation). In this case, there is a probability of 96% (0.96) that at least one of the element a of the matrix A and the element b of the matrix B will be 0.1 or less. In addition, the probability that both the element a and the element b will be greater than 0.1 is 4% (0.04). When the value is 0.1 or less, the effective bit length in the present embodiment can be reduced by 3 bits compared with the original fixed bit length of 8 bits, resulting in 5 bits. On the other hand, when both the element a and the element b are greater than 0.1, for simplicity of estimation, the effective bit length is assumed to be the maximum 8 bits (worst case). Therefore, the required calculation time relative to the conventional 8-bit fixed calculation is 0.96× 5/8+0.04× 8/8=0.64, as shown in the table of FIG. 11. As a result, the calculation speed is expected to be 1.6 times faster (=1/0.64) than the conventional method.

Similarly, Cases 2, 3, and 4 in FIG. 11 are cases where 80% of the matrix elements are 0.05 or less, 0.03 or less, and 0.015 or less, respectively. As in case 1, the effective bit length can be reduced by 4 bits, 5 bits, and 6 bits with a probability of 96%, resulting in effective bit lengths of 4 bits, 3 bits, and 2 bits, respectively. As a result, the required calculation times relative to the conventional 8-bit fixed calculation are 0.52, 0.40, and 0.28, respectively, as shown in the table of FIG. 11. Therefore, the calculation speeds are expected to be 1.9 times, 2.5 times, and 3.6 times faster than the conventional method, respectively.

As described above, by applying the present embodiment, matrix multiplication, which is a main operation in the DNN, can be accelerated several times. In addition, with this improvement in calculation speed, it is also possible to reduce power consumption by lowering the clock frequency. In this case, if the clock frequency is selected (reduced) to obtain the same calculation speed as in the conventional method, the power consumption can be reduced to a fraction of the conventional level. Thus, by applying, for example, the fourth embodiment, it is possible to expect several times faster calculation speed or power consumption reduced to a fraction of the conventional level in DNN matrix calculations.

As described above, by applying the present embodiment, even in cases requiring large-scale matrix multiplications, such as in generative AI, computations can be executed in real time with limited computational resources or can be executed under power capacity constraints. Therefore, efficient information processing becomes possible, leading to lower energy consumption, reduced carbon emissions, mitigation of global warming, and contribution to the realization of a sustainable society.
11: scheduler
12: memory
13: bit length variable matrix multiplication unit
13a, 13b: bit length variable multiplier
13c, 13d: accumulator
14: processing unit
15a, 15b: effective bit length calculation unit
21: bit length variable unit
22: multiplier
31: register
32: reset control unit
51: shift register (left bit shift)
52: counter
53: register
54: delay unit
55: subtractor
61: bit length variable unit
62: multiplier (bit serial×bit parallel)
71: shift register (left bit shift)
72: clock control unit
81a, 81b: bit length variable unit
91: bit length variable unit
92: multiplier
93a, 93b: selection unit
94: comparison unit
95: inverting unit
101a, 101b, 101c, 101d, 101e: matrix multiplication processing
102: matrix transposition process
103: Softmax calculation process

What is claimed is:

1. An information processing apparatus including a matrix multiplication unit including a multiplier and an accumulator, the matrix multiplication unit being configured to perform a matrix operation on an input signal to output an analysis result for the input signal, the apparatus comprising:
a bit length variable unit,
wherein, in the matrix operation, multiplication of a first matrix and a second matrix is performed to output a third matrix as a multiplication result,
in the multiplication, a first element of the third matrix is calculated, and in order to calculate the first element, multiplication of a second element of the first matrix and a third element of the second matrix is performed, and
the bit length variable unit performs the multiplication by setting the second element to have a first bit length based on a value of the third element.

2. The information processing apparatus according to claim 1,
wherein the bit length variable unit further performs the multiplication by setting the third element to have a second bit length based on a value of the second element.

3. The information processing apparatus according to claim 1,
wherein the bit length variable unit expresses the second element in a bit-serial form having the first bit length, and
the multiplier performs multiplication on a signal expressed in the bit-serial form with the number of clocks based on the first bit length.

4. The information processing apparatus according to claim 1,
wherein the bit length variable unit sets the first bit length based on a logarithm (base 2) of a value of the third element.

5. The information processing apparatus according to claim 1,
wherein the bit length variable unit performs the setting to the first bit length by replacing lower bits of the second element with zeros.

6. The information processing apparatus according to claim 4,
wherein the bit length variable unit obtains the first bit length by using a left bit shift of a shift register.

7. The information processing apparatus according to claim 2,
wherein the second element and the third element are compared, and when the third element is smaller, the multiplication is performed by setting the second element to have the first bit length based on the value of the third element, and
when the second element is smaller, the multiplication is performed by setting the third element to have the second bit length based on the value of the second element.

8. The information processing apparatus according to claim 1,
wherein the information processing apparatus is applied to matrix multiplication in an attention structure of a Transformer.

9. The information processing apparatus according to claim 1, further comprising:
an input unit; and
a memory,
wherein the memory stores the first matrix based on the input signal input from the input unit,
the memory stores the second matrix based on weight data set based on a DNN model,
the first matrix and the second matrix are input from the memory to the matrix multiplication unit and the third matrix is output as a multiplication result,
the third matrix is input to the matrix multiplication unit as the first matrix and information processing is performed by repeating multiplication with the second matrix, and
the memory stores an effective bit length of the third element corresponding to the value of the third element of the second matrix, and the bit length variable unit performs the multiplication by setting the second element to have the first bit length based on the effective bit length of the third element.

10. The information processing apparatus according to claim 1, further comprising:
an input unit;
a memory; and
an effective bit length calculation unit,
wherein the memory stores the second matrix based on the input signal input from the input unit,
the memory stores the first matrix based on weight data set based on a DNN model,
the first matrix and the second matrix are input from the memory to the matrix multiplication unit and the third matrix is output as a multiplication result,
the third matrix is input to the matrix multiplication unit as the second matrix and information processing is performed by repeating multiplication with the first matrix, and
the effective bit length calculation unit calculates an effective bit length of the third element of the second matrix input to the matrix multiplication unit, and the bit length variable unit performs the multiplication by setting the second element to have the first bit length based on the effective bit length of the third element.

11. An information processing method, comprising:
when a matrix multiplication unit including a multiplier and an accumulator performs a matrix operation on an input signal to obtain an output corresponding to the input signal, performing multiplication of a first matrix and a second matrix to output a third matrix as a multiplication result in the matrix operation;
calculating a first element of the third matrix in the multiplication, and in order to calculate the first element, performing multiplication of a second element of the first matrix and a third element of the second matrix; and
performing the multiplication by setting the second element to have a first bit length based on a value of the third element using a bit length variable unit.

12. The information processing method according to claim 11, further comprising:
performing the multiplication by setting the third element to have a second bit length based on a value of the second element using the bit length variable unit.

13. The information processing method according to claim 11,
wherein the bit length variable unit expresses the second element in a bit-serial form having the first bit length, and
the multiplier performs multiplication on a signal expressed in the bit-serial form with the number of clocks based on the first bit length.

14. The information processing method according to claim 11,
wherein the bit length variable unit sets the first bit length based on a logarithm (base 2) of a value of the third element.

15. The information processing method according to claim 12,
wherein the second element and the third element are compared, and when the third element is smaller, the multiplication is performed by setting the second element to have the first bit length based on the value of the third element, and
when the second element is smaller, the multiplication is performed by setting the third element to have the second bit length based on the value of the second element.
